(19) United States
(12) Patent Application Publication
(10) Pub. No.: US 2009/0056489 A1
(43) Pub. Date: Mar. 5, 2009

(54) PLASTIC GEAR, DRIVE WITH A PLASTIC GEAR AS WELL AS MANUFACTURING METHOD

(75) Inventors: Armin NIEDERER, Karlsruhe (DE); Diyap Bueyuekasik, Buehl (DE); Andrea Ganter, Buehlertal (DE); Marco Krauth, Sinzheim (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/198,441

(22) Filed: Aug. 26, 2008

(30) Foreign Application Priority Data
Aug. 31, 2007 (DE) 10 2007 041 530.5

(51) Int. Cl. F16H 57/04; F16H 1/16; B23P 15/14

(52) U.S. Cl. 74/425; 74/468; 29/893.31

(57) ABSTRACT

The invention relates to a plastic gear, particularly a worm gear, with teeth disposed side by side in circumferential direction. Provision is made according to the invention for the surface of at least one of the teeth to be structured in such a way as to constitute a grease depot. The invention additionally relates to a drive as well as to a method for introducing a structure, which constitutes a grease depot, into the surface of at least one tooth of a plastic gear.

### TECHNICAL FIELD

The invention deals with a plastic gear, particularly a worm gear according to the preamble of claim 1, a drive, particularly a worm drive according to claim 8, as well as a method according to the preamble of claim 9.

### BACKGROUND

A worm drive for the actuation of movable parts in a motor vehicle is known from the German patent DE 10 2004 028 610 A1. The worm drive comprises a gearing worm and a worm gear, which meshes with it. The worm gear consists of an injection molded part from plastic with a smooth gear tooth surface and a diameter of approximately 60 millimeters. The average surface roughness of known injection molded plastic gears is less than 1 micrometers. A series-production grease is used to lubricate the worm drive. In order to minimize the volume of installation space, efforts have been made to employ plastic worm gears with a smaller diameter. It was determined in continuous run tests that the worm gears with a smaller diameter are insufficiently lubricated on the external gearing of the worm gear, whereby total breakdowns of the worm drive can in turn occur. Even the use of highly viscous, cost intensive special greases merely led to a partial improvement in the lubricating effect on the gearing. A disadvantage when using highly viscous greases is the small self-locking capability of the worm drive, which partially results from their use. When the worm drive is used in a window actuating drive, such a small self-locking capability can lead to an undesirable, self-actuated opening of a window of the vehicle.

### SUMMARY

The task lying at the base of the invention is to propose an improved worm gear, whose employment prevents insufficient lubrication and assures a sufficient self-locking capability of a drive equipped with such a worm gear. The task additionally consists of proposing a correspondingly improved drive with a worm gear as well as a manufacturing method for such a worm gear.

This task is solved with regard to the worm gear from plastic by the characteristics of claim 1, with regard to the drive with the characteristics of claim 8 and with regard to the manufacturing method with the characteristics of claim 9. Advantageous modifications of the invention are stated in the sub-claims. All of the combinations of at least two characteristics, which are disclosed in the description, the claims and/or the figures, also fall within the scope of the invention.

The idea underlying the invention is to replace the injection molded plastic worm gears bearing a smooth gear tooth surface, which have been employed up until now, with a plastic worm gear, whose design includes a surface of at least one tooth, preferably all of the teeth, i.e. the entire external gearing, which is so rough that a grease depot is formed from the gear tooth surface. Standard series-production lubricating grease, which has been used up until now, has remained intact in this grease depot for the entire life of a drive, which is equipped with a plastic worm gear, which is designed according to the concept of the invention, and in so doing has provided a sufficient lubrication. On the basis of the embodiment according to the invention of the plastic worm gear, the diameter of the worm gear and thus the volume of installation space of a drive equipped with such a worm gear can be reduced. Moreover, the self-locking capability of the drive can be influenced by the selection of the surface structure, respectively the roughness of the surface. Because, as was previously mentioned, series-production greases, which have been commonly used up until now, can be employed with a plastic worm gear designed according to the concept of the invention, negative effects from the use of highly viscous and cost intensive lubricating greases on the self-locking capability of a drive equipped with such a plastic worm gear are avoided.

A form of embodiment of the plastic worm gear is particularly preferred, wherein the surface of the worm gear is provided with an average surface roughness, which is greater than 1 micrometer, preferably greater than 1.5 micrometers. The average surface roughness (ten point height) is ascertained as follows: initially a defined measuring section on the surface of at least the one tooth is divided into five equally large individual measuring sections. The difference between the maximum and the minimum value of the surface profile is then ascertained for each of these individual measuring sections. From the five values obtained in this manner, the average value, which constitutes the average surface roughness, is then calculated.

Good lubricant storage results were achieved by average surface roughness from a value range between approximately 1.5 micrometers and approximately 15 micrometers, whereby the performance declines of a drive equipped with a plastic worm gear, which is designed in this way, when the average surface roughness increases (decreasing degree of efficiency). Optimal lubrication values for the employment of such a plastic worm gear in window actuating drives were ascertained in an average surface roughness range between approximately 5 micrometers and approximately 10 micrometers, particularly between approximately 4 micrometers and approximately 7 micrometers.

There are various possibilities for introducing a structure, which constitutes a grease depot, into the surface of at least the one tooth. According to a first alternative, a plastic worm gear, particularly one manufactured by the injection mold method, is blasted with spherical blasting media. Good results were thereby achieved with glass beads. Conventional, series-production lubricating grease can optimally adhere to the rounded, trough-like depressions resulting from this process. Depending on the desired surface roughness, blasting media can be employed in a diameter range between approximately 50 micrometers and approximately 200 micrometers. The employment of blasting media with a particle diameter in a range between approximately 70 micrometers and approximately 150 micrometers is particularly preferred. Spherical blasting media are preferably employed with a particle diameter in a range between approximately 90 micrometers and approximately 110 micrometers.

A second alternative manufacturing method is optimally suited to a series-production of a plastic worm gear designed according to the concept of the invention. According to said method, the surface of at least the one tooth of the plastic worm gear is already produced during injection molding by means of a corresponding structuring of the surface of the injection molding die. In so doing, the injection molding die advantageously has a negative, i.e. congruent, structure in relation to the later structure of the surface of at least the one tooth. The employment of an injection molding die structured in this manner is recommended for roughened structures with an average surface roughness of maximally 5 micrometers. The danger exists for larger roughness depths, which are more than 5 micrometers, that the plastic worm gear can only be ejected from the injection molding die with difficulty and that plastic residues remain in the surface structure of the injection molding die. In order to achieve this greater surface roughness, the additional or alternative, immediate blasting of the injection molded plastic worm gear with spherical blasting media is recommended. The structuring of the injection molding die by blasting with spherical blasting media is proposed; and in so doing, glass beads as the blasting medium are particularly preferred for use. Good results were achieved with spherical blasting media, whose particle diameter lies in the range between approximately 50 micrometers and approximately 200 micrometers. The use of spherical blasting media with a particle diameter in a range between approximately 70 micrometers and approximately 150 micrometers is particularly preferred. Spherical blasting media with a particle diameter in a range between approximately 90 micrometers and approximately 110 micrometers are particularly preferred for structuring the injection molding die surface.

A form of embodiment of the plastic worm gear with an outside diameter in a range between approximately 35 millimeters and approximately 50 millimeters is particularly advantageous. The diameter of such a worm gear is preferably approximately 40 millimeters. By means of such small worm gears, the installation space requirement can be considerably reduced. The worm gear embodied as a worm-spur gear, which is equipped with a beveled external gearing, is particularly preferred.

Particularly good results with regard to the functionality and the saving of installation space were achieved with a plastic worm gear, which has between 40 and 50 teeth, preferably approximately 45 teeth. The surface of all of the teeth is thereby preferably roughened.

The invention also leads to a drive, preferably a worm drive, with at least one plastic worm gear designed according to the concept of the invention with a tooth surface structured to constitute a grease depot. The worm drive of the invention is particularly preferred to be a worm drive of an actuator in a motor vehicle application, especially for a window actuating mechanism, a seat adjustment device or a sun roof actuator.

The invention additionally leads to a method for introducing a structure constituting a grease depot into the surface of at least one tooth of the plastic worm gear. Provision is made according to the invention for the plastic worm gear to be directly blasted with blasting media, especially spherical ones, and/or for the plastic worm gear already during the injection molding process in the injection molding die to be structured to constitute a grease depot by means of a correspondingly structured injection molding die surface. The negative structure of the injection molding die required in this process can, for example, be introduced by blasting with blasting media and/or by eroding and/or by etching.

### BRIEF DESCRIPTION OF THE DRAWINGS

Additional advantages, characteristics and details of the invention result from the following description of preferred examples of embodiment as well as on the basis of the drawings. They show in:

FIG. 1 is a longitudinal section through a drive actuating unit, which is part of a window actuating device in a motor vehicle, and

FIG. 2 is an extreme close-up of the surface of teeth of the gear, which is configured as a worm gear, employed in the drive actuating unit according to FIG. 1.

### DETAILED DESCRIPTION

Identical components and components with the same function are denoted in the figures with the identical reference numbers.

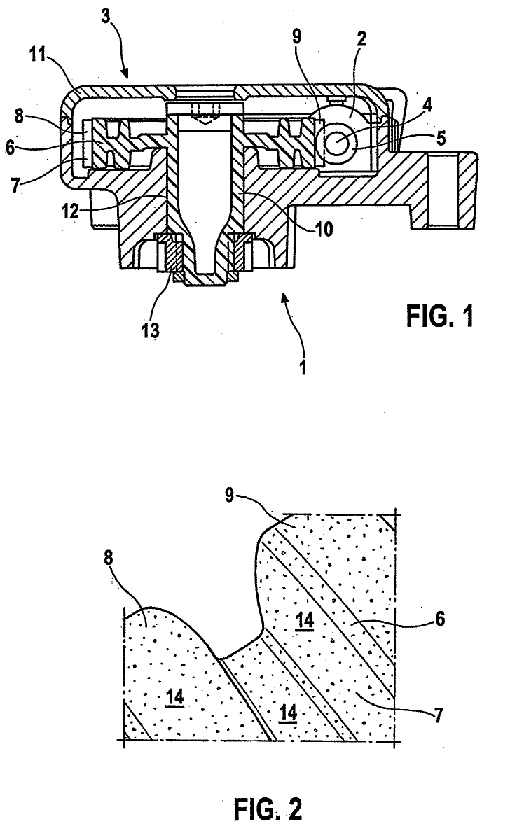

In FIG. 1, a longitudinal section through a drive actuating unit 1 is depicted. The drive actuating unit 1 comprises an electric motor drive 2 and a drive 3, which is driven by it. Said drive 3 is configured as a worm drive.

A gearing worm 5 made of metal is positioned torque proof on an overhung-mounted output shaft 4, which is driven by an electric motor drive 2. Said gearing worm 5 meshes with an external gearing 7 disposed on the outside circumference of a gear 6 made from plastic, which is configured as a worm gear. Said external gearing 7 comprises a plurality of teeth 8, 9 disposed side by side in circumferential direction. The surface 14 of the complete external gearing of the gear 6 is, as can be seen in FIG. 2, roughened and thereby constitutes a depot for series-production grease. The worm gear 6 is designed as a plastic injection molded part and has in its middle a cylindrical, axial extension 10, which axially extends through a housing 11, in which the worm drive 3 as well as the electric motor drive 2 are disposed. The axial extension 10 is designed as a hollow shaft with an external surface 12, which serves as the radial bearing surface for the worm gear 6. The outside diameter of the worm gear 6 is 40 millimeters in the example of embodiment depicted.

An output pinion 13, which interacts with an unspecified actuating mechanism in a motor vehicle, is driven by the worm gear 6.

In FIG. 2, a cut-out of the external gearing 7 of the worm gear 6 is shown in an enlarged depiction. Two teeth 8, 9 of said gearing 7 are visible, which are disposed side by side in circumferential direction and whose surface 14 is roughened, i.e. is structured in such a way, as to constitute a grease depot for series-production grease. The average surface roughness of the surface is approximately 4 micrometers in the example of embodiment depicted. The structure of the surface 14 assures that provision is made for a sufficient lubrication in the meshing region between the gearing worm 5 and the plastic worm gear 6 for the entire life of the drive actuating unit 1; and in so doing, a breakdown of the drive is advantageously avoided.

1. A plastic worm gear comprising;
a plurality of teeth positioned side by side in circumferential direction;
wherein at least one of the plurality of teeth includes a gear tooth surface that has a roughness structure to form a grease depot.

2. The plastic worm gear according to claim 1, wherein an average surface roughness of the gear tooth surface is greater than 1.0 micrometers, preferably greater than 1.5 micrometers, most preferably greater than 2 micrometers.

3. The plastic worm gear according to claim 1, wherein an average surface roughness of the gear tooth surface is between approximately 1.5 micrometers and approximately 15 micrometers, preferably between approximately 5 micrometers and approximately 10 micrometers.

4. The plastic worm gear according to claim 1, wherein the roughness structure of is produced by blasting the surface with a preferably spherical blasting media, particularly with a plurality of glass beads having an average diameter in a range between approximately 50 micrometers and approximately 200 micrometers, more preferably in a range between approximately 70 micrometers and approximately 150 micrometers, most preferably in a range between approximately 90 micrometers and approximately 110 micrometers.

5. The plastic worm gear according to claim 1, wherein the roughness structure is produced using an injection molding die during an injection molding of the worm gear, and wherein a surface of the injection molding die is provided with a negative structure that is preferably produced by blasting the surface with a preferably spherical blasting media, particularly with a plurality of glass beads having an average diameter in a range between approximately 50 micrometers and approximately 200 micrometers, more preferably in a range between approximately 70 micrometers and approximately 150 micrometers, most preferably in a range between approximately 90 micrometers and approximately 110 micrometers.

6. The plastic worm gear according to claim 1, wherein a diameter of the plastic worm gear is between approximately 35 millimeters and approximately 50 millimeters, preferably approximately 40 millimeters.

7. The plastic worm gear according to claim 1, wherein the plastic worm gear has between approximately 30 teeth and 100 teeth, preferably approximately 45 teeth.

8. The plastic worm gear according to claim 1, wherein at least one plastic worm gear is used in a drive, particularly a worm drive, for use in a motor vehicle application.

9. A method of forming a roughness structure to form a grease depot on a gear tooth surface on a tooth of a plastic worm gear having a plurality of teeth positioned side by side in circumferential direction, the method comprising at least one of:
blasting the gear tooth surface with a preferably spherical blasting media; and
forming a negative structure on a surface of an injection molding die, wherein the negative structure is formed by at least one of:
i) blasting the surface with a preferably spherical blasting media;
ii) eroding the surface of the injection molding die; and
iii) etching the surface of the injection molding die.
